(19) United States
(12) Patent Application Publication
(10) Pub. No.: US 2008/0313482 A1
(43) Pub. Date: Dec. 18, 2008

(54) Power Partitioning Memory Banks

(75) Inventors: Sainath Karlapalem, Bangalore (IN); Milind Manohar Kulkarni, Sunnyvale, CA (US)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/158,983

(22) PCT Filed: Dec. 20, 2006
(86) PCT No.: PCT/IB06/54964

§ 371 Date: Jun. 23, 2008

Related U.S. Application Data
(60) Provisional application No. 60/752,857, filed on Dec. 21, 2005.

(51) Int. Cl. G06F 1/32; G06F 9/50; G06F 12/02

(52) U.S. Cl. 713/324; 718/104; 711/173

(57) ABSTRACT

The present invention comprises a plurality of memory banks (102, 103) with independent power controls (110) such that any memory banks (102, 103) not actively engaged in storing partitioned data can be powered down by dynamic voltage scaling. A memory management unit (112) is used to re-map partitions so they occupy fewer banks of memory, and a re-partition processor (102) is used to compute how partitions can be packed and squeezed together to use fewer banks of memory. Overall system power dissipation is therefore reduced by limiting the number of memory banks (102, 103) being powered up.

The present invention relates to power conservation in electronic devices, and more particularly to methods and circuits for conserving electrical energy in microcomputers by partitioning multi-bank cache/memories to reduce the number of banks that must be powered.

A system's power efficiency depends on how well the hardware is matched with an application's operating behavior. See, Robert Cravotta, “Squeeze Play: Wring the power out of your design,” EDN Magazine, Feb. 19, 2004. Lower system-power dissipation benefits both battery-powered applications and many high-performance wired systems. Decisions regarding the system and software architecture can significantly impact the overall processing performance, power consumption, and electromagnetic-interference (EMI) performance. Lower overall power consumption in battery-powered systems can increase battery life and allow smaller batteries to be used to minimize a system's size, weight, and cost.

For wired systems, lower power dissipation can result in reducing system requirements for cooling fans and air-conditioning, because the system generates less heat. Reducing the cooling requirements allows a system to operate more quietly, because smaller power supplies and fewer/quieter fans can be used. Lowered peak power dissipation in wired systems enables increases in component density that would otherwise be constrained by hot-spot limits. Lowering a design's power consumption can also reduce a system's overall size and cost.

Robert Cravotta writes that matching hardware power techniques and software-architecture decisions with an application's expected operating behavior can yield significant power savings. The total power dissipation of a CMOS circuit comprises both static and dynamic power dissipation. Static power dissipation, includes transistor leakage currents, an exists even when a circuit is inactive, independent of any switching activity. Leakage currents in CMOS devices include reverse-bias-source, drain-diode currents, drain-to-source weak-inversion currents, and tunneling currents. Choices in process technology and cell libraries affect how large these leakage currents will be. Static power dissipation often represents the majority of the total power for applications that rely mostly on event-response operation separated by long idle periods.

Dynamic, or active, power dissipation is drawn when the logic clocks. The power dissipation is proportional to the system voltage, clock frequency, and dynamic capacitances. Dynamic power dissipation usually dominates the system-power efficiency for continuously operating applications. A system's dynamic capacitance is fixed, based on the process technology and cell libraries it uses. The supply voltage has the largest proportional influence on power consumption. A higher clock frequency usually requires a higher relative supply voltage within the same process technology.

Many processor devices include sleep, standby, or low-power modes that cut-off power to peripheral devices, processor cores, clock oscillators, and other specific modules. Selectively shutting down the power to various modules can reduce the overall dynamic and static power dissipation. Circuit blocks that would otherwise not be performing useful work are not needlessly consuming power.

Low-power modes often preserve power to the memory structures so program counters and registers can be saved for a hot restart. A time delay is needed to restore these registers and for the supply voltage clocks to stabilize. For this reason, powering down modules is impractical when they will only be idle for less than the stabilization time, or when they need to more quickly respond to an event than the stabilization time allows. Powering down modules usually relies on software, e.g., in the BIOS, operating-system, or application level.

Power dissipation from a device's clock tree can represent as much as 50% of the chip's total power, because the clock signal is typically operating at least twice the frequency of any other signal, and it needs to propagate everywhere. Systems may be partitioned to use different clock domains for various modules and components. Especially when the entire system does not need to operate at the higher clock speeds. Lower clock frequencies reduce power dissipation, and reduced fast edge rates produce fewer spurious emissions that can cause local interference.

Clock gating is a dynamic power-management technique that cab be independent of and transparent to software. It reduces dynamic power dissipation and EMI by stopping or slowing the switching activity triggered by the clocks. Clock gating does not remove power from a functional block, so it does not affect static power dissipation. Clock gating does not cause start-up-time delays, so it can be effective on a clock-by-clock basis.

Clock gating can stop the clock from propagating to components that do not need to be active at any one time, e.g., buses, cache memories, functional accelerators, and peripherals. To be practical, the clock-gating control logic power dissipation should be less than the resulting overall power reduction.

Clock dividers and integrated low-speed clock sources can be used to scale the clock frequency. An integrated low-speed clock source can support a dual-speed start-up when restarting modules and a high-speed clock source. The core or module can begin operation using an internal, fast-starting but lower power and slower clock source. It can transition to the faster clock source after the circuit becomes stable.

Dynamic voltage scaling is a power-management technique relies on software control, that can give dramatic global savings in power. A set of frequency and voltage pairs for a given device is determined during characterization to provide a sufficient processing performance margin under all supported operating conditions. A higher clock frequency is engaged after the corresponding increase in supply voltage stabilizes. Going to a lower clock frequency can be timed with an immediate reduction in power supply voltage, because the previous supply voltage is already higher than will be necessary to support the new lower clock frequency.

Properly sizing on-chip memory, register files, and caches, to an application's needs can significantly affect power dissipation by minimizing expensive off-chip memory accesses. But not all applications need all the resources all the time. Connecting to off-chip resources, such as external memory, increases dynamic capacitance compared to on-chip resources. Such increases cause more dynamic power to be dissipated. The dynamic capacitance of memory banks can be lowered by placing them closer to the core. So using register files and caches can do more than just speed data and instruction accesses. Such closer placements can also contribute to lower overall power dissipation. Cache-locking is a technique that can force a block of code to run entirely from cache to avoid external memory accesses. Including too much memory in a design can mean power is being wasted by incurring more leakage currents than necessary.

Robert Cravotta writes in his EDN article that partitioning memory into banks, and supporting low-power modes when a bank of memory is idle, can provide further power savings. Memory is idle only when it contains no useful data, and differs from when an application is currently not accessing the memory. The optimal size and number of memory banks is application-specific. It depends, for example, on application size, data structures, and access patterns. The availability of on-chip flash or EEPROM nonvolatile memory can enable lower-power sleep modes for the memory banks, e.g., if the amount of state data to save is small enough and the processing idle periods are long enough.

Power-reducing techniques can be independent of and transparent to software. But power-aware software should be used to harness the full potential of power-management. Power-aware software may be included within the BIOS, peripheral drivers, operating system, power-management middleware, and application code. The closer the power-aware code is written to the application code, the more application-specific will be the decisions it can make, and the more power-efficient.

Tsafrir Israeli, et al., describe cache memory power saving techniques in United States Patent Application US 2004/0128445 A1, published Jul. 1, 2004. Such depends on having at least one each memory bank in which parts of it can be separately powered and controlled. Such suggests that there are better ways of providing cache memory that save energy than by dividing the memory into banks and controlling only whole banks. It does not teach how only those portions storing important cache data are to remain powered while the other portions are powered off.

The static determination of cache partitions and applying dynamic voltage scaling (DVS) to such partitions that are inactive was addressed by Erwin Cohen, et al., in United States Patent Application US 2005/0080994 A1, published Apr. 14, 2005.

Alberto Macii, Enrico Macii, and Massimo Poncino describe “Improving the Efficiency of Memory Partitioning by Address Clustering,” Proceedings Design, Automation and Test in Europe Conference and Exhibition, Munich, Germany, 3-7 Mar. 2003. They say that memory partitioning can be used for memory energy optimization in embedded systems. The spatial locality of the memory address profile is the key property that partitioning exploits to determine an efficient multi-bank memory architecture. Address clustering increases the locality of a given memory access profile and improves the partitioning efficiency.

What is needed, and what has been missed so far, is a power-aware dynamic re-partitioning mechanism, which considers performance trade-offs in making partitioning decisions.

This invention provides a circuit for saving power in multi-bank memory systems.

A circuit embodiment of the present invention comprises a plurality of memory banks with independent power controls such that any memory banks not actively engaged in storing partitioned data can be powered down by dynamic voltage scaling. A memory management unit is used to re-map partitions so they occupy fewer banks of memory, and a re-partition processor is used to compute how partitions can be packed and squeezed together to use fewer banks of memory. Overall system power dissipation is therefore reduced by limiting the number of memory banks being powered up.

An advantage of the present invention is that a circuit and method are provided for reducing power dissipation in a memory system.

Another advantage of the present invention is that a circuit and method are provided that extend battery life in portable systems.

A further advantage of the present invention is that a circuit and method are provided that can reduce heating and the concomitant need for cooling in electronic systems.

These and other objects and advantages of the present invention will no doubt become obvious to those of ordinary skill in the art after having read the following detailed description of the preferred embodiments which are illustrated in the various drawing figures.

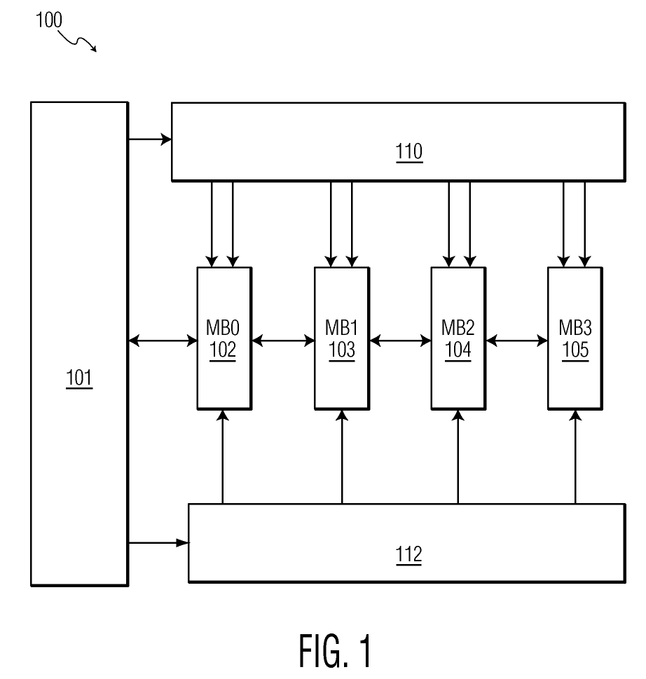

FIG. 1 is a functional block diagram of a system embodiment of the present invention;

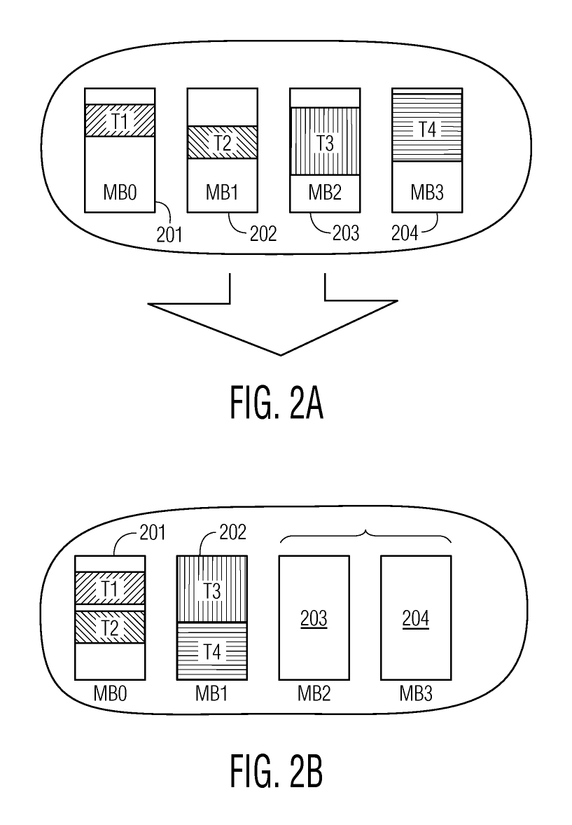

FIGS. 2A and 2B are partition mapping diagrams showing an example of four partitions spread across four memory banks in FIG. 2A being re-mapped and re-partitioned to fit in two memory banks in FIG. 2B;

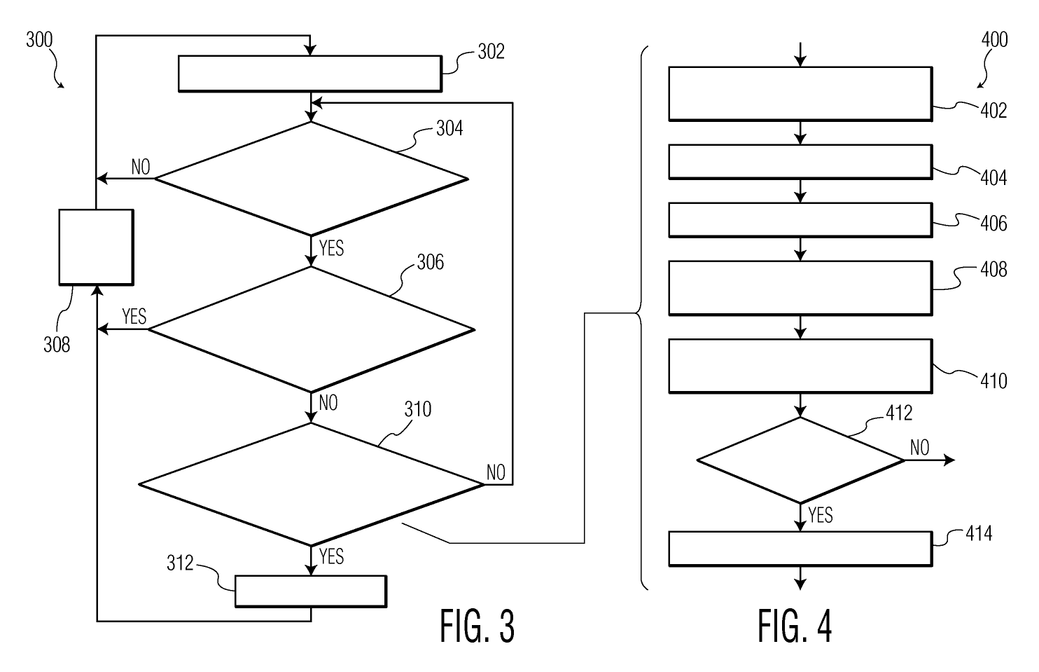

FIG. 3 is a flowchart diagram of a power-saving method embodiment of the present invention useful in the system of FIG. 1 to accomplish the actions illustrated in FIGS. 2A and 2B; and

FIG. 4 is a flowchart diagram of a memory re-partitioning method embodiment of the present invention useful as a subroutine in the method shown in FIG. 3.

FIG. 1 represents a system embodiment of the present invention, and is referred to herein by the general reference numeral 100. System 100 comprises a processor (CPU) and program 102 that accesses four memory banks (MB0-MB3) 104-107. Each is independently powered and clocked by a dynamic voltage scaling unit 110. Such can speed up and slow the clocks supplied to the memories, it also adjusts the voltage to be high enough for the particular clock speed being supplied to work properly. A memory mapping unit (MMU) 112 converts the physical addresses of the four banks of memory into logical addresses for the CPU 102. In operation, the MMU logically maps memory so that a minimum number of memory banks 102-105 need to be operated at maximum performance by the DVS unit 110. The system 100 does this by re-mapping and re-partitioning tasks executing from the program. The memory banks 102-105 represent either main memory or cache memory, as the principles of operation to save power here are the same.

Portable electronic devices can conserve battery operating power by incorporating system 100. For example, a personal digital assistant (PDA) handheld device that combines computing, telephone/fax, Internet and networking features supported by an embedded microcomputer system. A typical PDA can function as a cellular phone, fax sender, Web browser and personal organizer. A popular brand of PDA is the Palm Pilot from Palm, Inc. Mobile, cellular telephones can also benefit by using the technology included herein.

FIGS. 2A and 2B illustrate how four banks of memory (MB0-MB3) 201-203 could, for example, have four different tasks (T1-T4) spread across them. This would needlessly waste power, because in FIG. 2A, all four banks of memory (MB0-MB3) 201-203 would need to be operated at full power and with maximum clock speeds. A re-mapping and re-partitioning, as in FIG. 2B, puts all four tasks T1-T4 in just the first two memory banks MB0 201 and MB 1 202. The third and fourth memory banks, MB2 203 and MB3 204, can be scaled down to save power, e.g., by DVS 110 (FIG. 1).

FIG. 3 represents a method 300 for re-mapping and re-partitioning tasks across more than one independently powered memory bank. The method 300 includes a step 302 that applies dynamic voltage scaling to any memory banks that have been idled of storage duties. A step 304 tests to see if task partitions are spread across more than one memory bank. At minimum, one bank must be kept operational, and one other memory bank can be scaled down. A step 306 inspects the organization of task partitions and memory banks to see if a simple re-mapping can provide power reduction benefits. If so, a step 308 re-maps the task partitions in the memory banks. A step 310 inspects further to see if some packing of the memory banks can be done by re-partitioning smaller and re-mapping into fewer memory banks. The details of step 310 are further expanded in FIG. 4. If re-partitioning is decided to be practical, then a step 312 re-partitions the tasks for re-mapping by step 308.

FIG. 4 represents a re-partitioning method 400. In a step 402, an activity profile is generated for the scheduling instances. Scheduling instances provide information about the activity profile of different tasks, which will be used to decide upon which partitions need to be resized. The type of footprint needed in the partitions is computed in a step 404. The marginal loss is determined in a step 406. There is a marginal loss per partition that will be incurred if the partition sizes are reduced to fit a particular memory bank. Such marginal loss relates to increased number of cache misses. Task priorities and quality of service (QoS) requirements are assessed in a step 408. Considering the priorities of different tasks, their deadlines, and the marginal loss together inherently makes use of QoS requirements for choosing how to adjust the partitions.

Differences in the processing rates are analyzed in a step 410. The processing-rate differences of various processes are absorbed by adjusting their relative partitions. For example, the partition for a fast process is chosen for resizing so that we can absorb processing rate difference between fast and slow processes. In the example shown in FIGS. 2A and 2B, the partition size corresponding to task T4 is decreased keeping into account all the above parameters so that now the combined size of the partitions for tasks T3 and T4 will fit in the single memory bank MB 1 202. This results in two memory banks left unused so that DVS can be applied to minimize the power consumption.

So a step 412 determines if there is a re-partitioning that is practical. If so, a step 414 passes on the parameters of that re-partitioning, e.g., in FIG. 1, for the CPU 102 to implement in MMU 112.

Embodiments of the present invention include a power minimization technique that uses partitioning information in cache/memory subsystems. Partitions chosen for individual compute kernels that are sharing the cache/memory are clustered to accommodate required memory banks, thereby avoiding unnecessary spreading of partitions across different memory banks. Such clustering of partitions provides optimal usage of memory banks allowing more freedom for dynamic voltage switching off of unoccupied banks.

Although the present invention has been described in terms of the presently preferred embodiments, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the “true” spirit and scope of the invention.

1. A circuit, comprising: at least two banks of memory for which power consumption can be independently and individually controlled; a power controller connected to supply each of the banks of memory such that at least one memory bank can be powered down to conserve power; a memory management unit (MMU) for mapping the banks of memory into a memory space; and a processor (CPU) for computing memory mapping and partitioning, and connected to instruct the MMU to re-map and re-partition memory, and connected to command the power controller to reduce the number of banks of memory powered.

2. The circuit of claim 1, wherein the power controller further comprises a dynamic voltage scaling unit for a scaling of both voltage and clock frequency applied to the banks of memory.

3. The circuit of claim 1, wherein: the CPU provides for re-mapping and re-partitioning tasks across more than one independently powered memory bank by applying dynamic voltage scaling to any memory banks that have been idled of storage duties, and seeing if any task partitions are spread across more than one memory bank, and inspecting a current organization of task partitions and memory banks to see if a simple re-mapping can provide power reduction benefits, and re-mapping task partitions in the memory banks, and inspecting further to see if some packing of the memory banks can be done by re-partitioning smaller and re-mapping into fewer memory banks, and re-partitioning tasks and re-mapping to fewer numbers of banks of memory.

4. The circuit of claim 1, wherein: the CPU provides for re-mapping and re-partitioning tasks across more than one independently powered memory bank by generating an activity profile for scheduling instances, and computing the type of footprint needed in the partitions, and determining the marginal loss per partition that will be incurred if partition sizes are reduced to fit a particular memory bank, and assessing task priorities and quality of service requirements, and analyzing differences in processing rates, and deciding if a re-partitioning is practical and, if so, passing on the parameters for that re-partitioning to be implemented by the MMU.

5. A method for conserving operating power in a memory system, comprising: re-mapping and re-partitioning tasks across more than one independently powered memory bank by applying dynamic voltage scaling to any memory banks that have been idled of storage duties; testing if any task partitions are spread across more than one memory bank; inspecting a current organization of task partitions and memory banks to see if a simple re-mapping can provide power reduction benefits; re-mapping task partitions in the memory banks; inspecting further to see if some packing of the memory banks can be done by re-partitioning smaller and re-mapping into fewer memory banks; and re-partitioning tasks and re-mapping to fewer numbers of banks of memory.

6. The method of claim 5, further comprising: re-mapping and re-partitioning tasks across more than one independently powered memory bank by generating an activity profile for scheduling instances; computing the type of footprint needed in the partitions; determining a marginal loss per partition that will be incurred if partition sizes are reduced to fit a particular memory bank; assessing task priorities and quality of service requirements; analyzing differences in processing rates; and deciding if a re-partitioning is practical and, if so, passing on a set of parameters for a re-partitioning for action by a (MMU).

7. A microcomputer system for a personal digital assistant, comprising: at least two banks of memory for which power consumption can be independently and individually controlled; a power controller connected to supply each of the banks of memory such that at least one memory bank can be powered down to conserve power; a memory management unit (MMU) for mapping the banks of memory into a memory space; and a processor (CPU) for computing memory mapping and partitioning, and connected to instruct the MMU to re-map and re-partition memory, and connected to command the power controller to reduce the number of banks of memory being powered.
